(19) United States
(12) Patent Application Publication
(10) Pub. No.: US 2008/0274785 A1
(43) Pub. Date: Nov. 6, 2008

(54) Gaming System

(76) Inventors: Stephen Byng, Cherrybrook New South Wales (AU); Michael Ian Jones, Matraville New South Wales (AU)

Correspondence Address: Lawrence M. Jarvis;McAndrews, Held & Malloy, 500 W. Madison Street, 34th Floor, Chicago, IL, 60661, US

(21) Appl. No.: 11/629,333

(22) PCT Filed: Jun. 10, 2005
(86) PCT No.: PCT/AU05/00836

§ 371 Date: May 28, 2008

(30) Foreign Application Priority Data
Jun. 10, 2004 (AU) 2004903175

(51) Int. Cl. A63F 13/00

(52) U.S. Cl. 463/20

(57) ABSTRACT

This invention relates to a gaming system (50) involving one or more gaming machines (52, 54) and a plurality of servers (56, 58) connected thereto. In a one embodiment a gaming machine (52, 54) has a plurality of client software components (52.1, 52.2) configured to interact with a plurality of servers (56, 58) to control different aspects of the gaming system.

### FIELD OF THE INVENTION

This invention relates to a gaming system involving one or more gaming machines and a plurality of servers connected thereto.

### BACKGROUND TO THE INVENTION

In the gaming industry, it is known to have a number of electronic gaming machines each connected to one or more game servers which control or manage games played on the gaming machines. It is also known to have additional servers for controlling the operation of other non-game functions and features of the system such as game promotions, jackpots or the like. In a gaming system where there are a number of servers providing games services to the gaming machines and a number of servers providing non-game services to the gaming machines, the system may be considered as having multiple game service providers and multiple non-game service providers.

Referring now to FIG. 1, which shows a related art system 100 which includes pair of gaming machines 102 and 104, a game server 106, an event server 108, and a data storage means 110. Each of the gaming machines 102 and 104 is connected to each of the servers 106 and 108, and the servers are connected to the data storage means 110 by means of data network 112 as shown.

The event server 108 is configured to implement a non-game event being an action or sequence of actions that is not part of a game implemented by the game server 106: Such events are not directly related to the base game, but may have an affect on its outcome or operation. Non-game events run on an event server such as 108 can include a jackpot, a promotion, or secondary or feature game.

In the system 100 each gaming machine 102 and 104 includes a single client that cooperates with both the game server 106 and the event server 108 to enable playing of a game on the respective gaming machine and implementation of the non-game feature provided by the event server 108.

In such a system if the gaming machines 102 and 104 were made to play different games or one of the gaming machines was not linked to the event server 108, then the client systems running on the respective gaming machines 102 and 104 would need to be different.

Such a requirement limits the ability of system operators to reconfigure systems and adds to the expense and development cost for system designers, who need to build different client systems for each possible machine configuration.

It is an object of the invention to address or ameliorate one or more of the disadvantages of prior art systems and to propose an alternative system. Insofar as the invention is intended to propose an alternative to existing systems, it may also yield further advantages as will become apparent below.

### SUMMARY OF THE INVENTION

According to an aspect of the invention there is provided a gaming system including:
a plurality of gaming machines each having a player display interface, player control interfaces, a game client and an event client;
a game server connected to at least one of the game clients; and
an event server connected to at least one of the event clients,

wherein each of the game clients is configured, in conjunction with the game server, to enable a game to be played thereon, and each of the event clients is configured to handle an event, which does not constitute part of said game, by receiving signals from an event server relating to the event and by causing information about the event to be displayed on said display interface.

Preferably, the event client of each gaming machine is configured to handle the event by responding to commands, relating to the event, input by the respective player using said player control interfaces.

In a preferred embodiment, each gaming machine is configured to prevent a game from being played by the respective game client in conjunction with the game server, while the event client is handling an event.

According to another aspect of the invention there is provided a gaming system including:

a plurality of gaming machines each having a player display interface, a game client and at least one peripheral component constituting a component client;

a game server connected to at least one of the game clients; and a component server connected to the component client,

wherein the game client is configured, in conjunction with the game server, to enable a game to be played on a gaming machine, and the component client is configured to send signals to the component server, relating to operation of the peripheral component constituting that component client.

Preferably, the component client is configured to receive signals from the component server relating to said peripheral component.

In a third aspect there is provided a method for operating a gaming machine played by a player, the gaming machine of the type having a display, said method comprising: controlling the display with a game client in cooperation with a game controlling server to display game outcomes; providing an event server configured to control at least a portion of the display in cooperation with an event client resident on the gaming machine to display an event; wherein, at least between the display of game outcomes, said event server and event client cooperate to control the display to display event data.

Preferably at least one of said event server or game server suspending control of the display of said event data until a predetermined interruption of the display of game play outcomes. The player can preferably input data during the period in which said event server controls the display. The method can include the player inputting data during the period in which said event server controls the display to interact with an event.

In another aspect the present invention provides a gaming system including at least one gaming machine operably connected to two or more servers; said gaming machine being configured to run at least one game client application configured to cooperate with a game server to enable a game to be played on the gaming machine and at least one second client configured to cooperate with a second server to implement a second functionality of the gaming machine.

The at least one second client can include:

an event client application configured to cooperate with an event server to enable the operation of an event involving the gaming machine;

a component client configured to cooperate with a component server to control the operation of one or more physical components of the gaming machine; and/or

a feature game client configured to cooperate with a feature game server to control the operation of one or more feature games playable on the gaming machine, wherein said feature game is not related to one or more base games playable on the gaming machine.

An event client can be configured to implement one of the following:

the operation of a jackpot;

the operation of a competition;

the operation of a promotion; or

the operation of a bonus feature not forming part of a base game implemented by a game client/server combination of the system.

A component client can be configured to control the operation of one or more of the following gaming machine components:

a display

a credit input means;

an auditing component;

an audio system:

a player identification system;

a player input system; and

a credit payout system.

The gaming machine can further include at least one client switching component configured to switch the control of the gaming machine between different client applications to enable the operation of either an event or a game.

In another aspect the present invention provides a gaming machine including at least one data storage component for storing at least one game client application and at least one second client application and processing means configured to run one or more of said client applications to control the operation of the gaming machine, wherein said gaming machine is configured to be operable under the control of game client application to enable a game to be played thereon, and to be operable under the control of a second client application to implement a second function of the gaming machine.

The second client can be selected from one of the following:

an event client, configured to enable the gaming machine to take part in an event;

a component client configured to control the operation of components of the gaming machine; and

a feature game client, configured to enable the gaming machine to take part in feature game that is not related to one or more base games playable on the gaming machine.

The gaming machine can also include a client switching component configured to switch the control of the gaming machine from one client application to another.

Preferably an event client is configured to implement one of the following events:

the operation of a jackpot;

the operation of a competition;

the operation of a promotion; or

the operation of a bonus feature not forming part of a base game implemented by a game client/server combination of the system.

The component client is preferably configured to control the operation of one or more of the following gaming machine components:

a display

a credit input means;

an auditing component;

an audio system:

a player identification system;

a player input system; and

a credit payout system.

In yet another aspect of the present invention there is provided a method of operating a gaming machine including at least one data storage component for storing at least one game client application and at least one second client application and processing means configured to run one or more of said client applications to control the operation of the gaming machine, said method including:

controlling the operation of the gaming machine with a game client application to enable a game to be played thereon; and

controlling the operation of the gaming machine with a second client application to enable a second function to be performed by the gaming machine.

The method can further include:

switching control of the gaming machine from one client application to another to enable control of a different function of the gaming machine.

The second client is preferably selected from a list including:

an event client configured to enable the gaming machine to take part in an event;

an component client configured to enable the gaming machine to control a component of the gaming machine; and

a feature game client configured to enable a feature game, not related to one or more base games playable on the gaming machine, to be played on the gaming machine.

### BRIEF DESCRIPTION OF THE DRAWINGS

Preferred embodiments of the invention will now be described, by way of non-limiting example only, with reference to the accompanying drawings, in which:

FIG. 1 is a block diagram representing a related art system;

FIG. 2 is a block diagram representing a gaming system according to an embodiment of the present invention;

FIG. 3 is a schematic perspective view of a gaming machine according to an embodiment of the invention;

FIG. 4 is a schematic diagram of a control system of the gaming machine of FIG. 3;

FIG. 5 is a flow chart representing a sequence of events in relation to the use of the system of FIG. 3;

FIG. 6 is a block diagram representing a gaming system according to another embodiment of the invention; and

FIG. 7 is a block diagram representing a gaming system according to yet another embodiment of the invention

### DETAILED DESCRIPTION

FIG. 2 depicts a gaming system 50 according to an embodiment of the present invention. The system 50 includes a pair of gaming machines 52 and 54, a game server 56, an event server 58 and a data storage means 60.

As will be appreciated in certain embodiments, there may be a far greater number of gaming machines and servers included in a system; but for simplicity in illustrating embodiments of the present invention, only two gaming machines and servers are depicted.

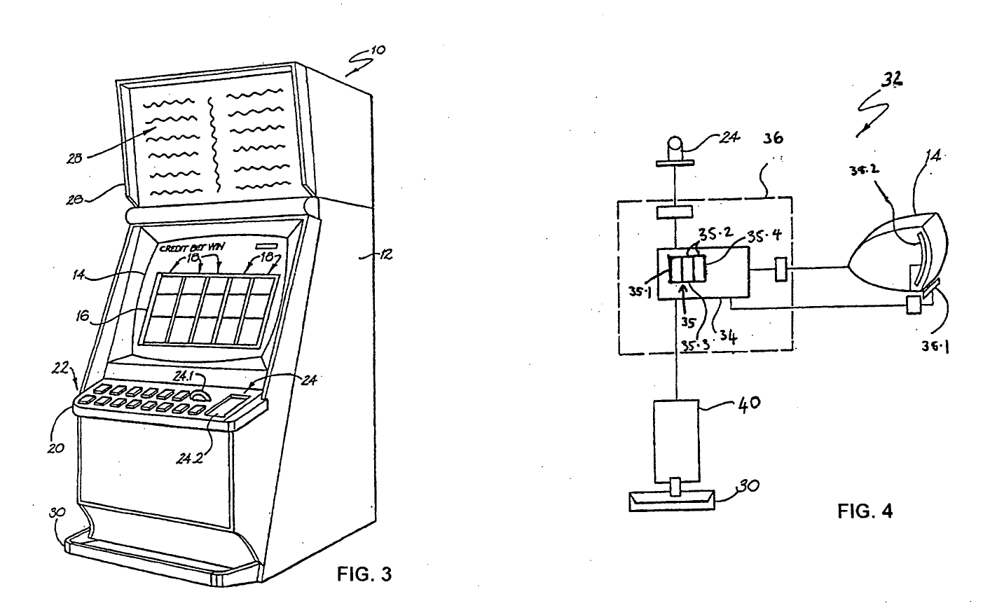

Each gaming machine 52 and 54 includes a game client, designated 52.1 and 54.1 respectively, as well as an event client designated 52.2 and 54.2, respectively. The game clients 52.1 and 54.1 are connected to the game server 56 by respective connections 62 while the event clients 52.2 and 54.2 are connected to the event server 58 by further respective connections 64. The game and event servers 56 and 58 are connected to the data storage 60 by connections 65. The gaming machines 52 and 54 are identical to each other. Further details of the gaming machines are described in relation to FIGS. 3 and 4.

In FIG. 3, reference numeral 10 generally designates a gaming machine operable in an embodiment of the present invention. The machine 10 includes a console 12 having a display means in the form of a video display unit 14 on which a game 16 is played in use. The video display unit 14 may be implemented as a cathode ray screen device, a liquid crystal display, a plasma screen, or the like. The game 16 may be a spinning reel game as depicted, or any other type of game playable on an electronic gaming machine. In this example the game 16 simulates the rotation of a number of spinning reels 18, preferably from three to five. A midtrim 20 of the machine 10 houses a keypad 22 containing buttons for enabling a player to make inputs into the gaming machine to interact with the game 16 and other non-game features associated with the gaming machine. The midtrim 20 also houses a credit input mechanism 24 including a coin input chute 24.1 and a bill collector 24.2.

The machine 10 includes a top box 26 on which artwork 28 is carried. The artwork 28 includes paytables, details of bonus awards, etc. A coin tray 30 is mounted beneath the console 12 for cash payouts from the machine 10.

Referring to FIG. 4 of the drawings, a control means or control circuit 32 of the gaming machine 10 is illustrated. The control circuit 32 includes at least one processor 34 which runs at least one game client program 35.3 which interacts with a server of the gaming system to implement the game 16. The at least one processor 34 also runs at least one event client program 35.4 which interacts with an event server of the gaming system to enable a user of the gaming machine to interact with an event.

The processor 34 is associated with a memory device 35 and forms part of a controller 36 that drives the screen of the video display unit 14 and that receives input signals from sensors, which include sensors 38.1 associated with the keypad 22 and touch sensors 38.2 mounted in the screen of the video display unit 14.

The controller 36 also receives input pulses from the mechanism 24 to determine whether or not a player has provided sufficient credit to commence playing. The mechanism 24 may, instead of the coin input chute 24.1 or the bill collector 24.2, or in addition thereto, be a credit card reader (not shown) or any other type of validation device.

The memory device 35 includes RAM 35.1 for storing game and event data generated in the course of the operation of the gaming machine, and at least one client program storage portion 35.2 for storing client program code which controls the operation rules and paytables of the game, and the operation of an event accessible to the gamine machine 10. In the present example, the client program code includes a game client application 35.3 and an event client application 35.4 stored in the client program storage portion 35.2. The client program storage portion 35.2 will typically be in the form of a ROM, PROM or EPROM, or optionally in some embodiments as a RAM.

Finally, the controller 36 drives a payout mechanism 40 which, for example, may be a coin hopper for feeding coins to the coin tray 30 to make a payout to a player when the player wishes to redeem his or her credit.

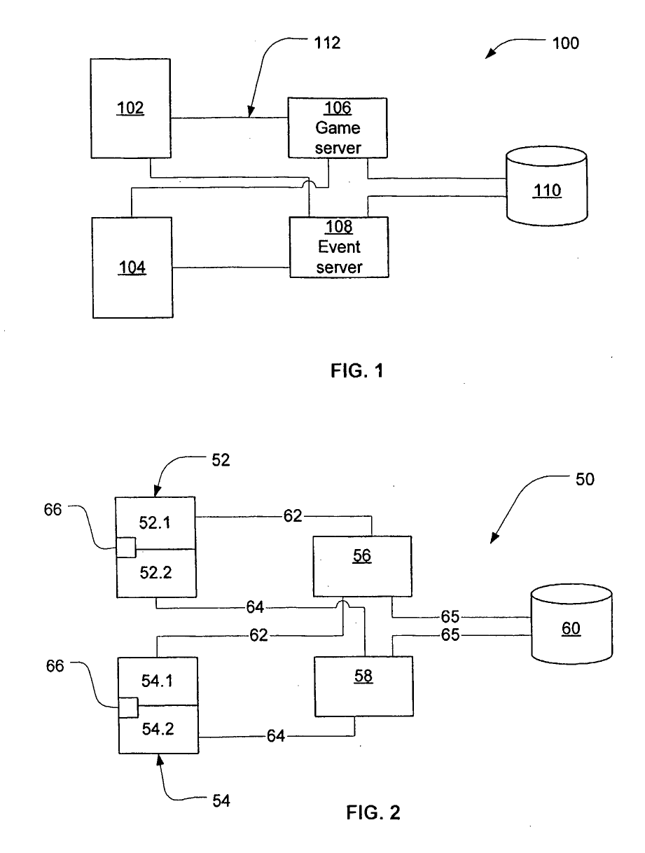

Returning now to FIG. 2, the game server 56, event server 58 and data storage means 60 perform similar functions to the equivalent components depicted in FIG. 1. In the present embodiment however, the game client 52.1 and 54.1 of each gaming machine 52 and 54 communicates with the game server 56 via the connections 62, to control games played on the respective gaming machines 52 and 54. Similarly, the event client 52.2 and 54.2 of each gaming machine 52 and 54 communicates with the event server 58, via the connections 64, to enable the communication of event information.

In one preferred embodiment of the invention the gaming machines 52 and 54 are each provided with a switching means 66 for switching between the respective game clients 52.1 and 54.1 and event clients 52.2 and 54.2. Thus, each gaming machine 52 and 54, by making use of the switching means 66, can alternate between two alternate modes of operation. One of these modes is a game mode in which a gaming machine 52 or 54 generates a game under control of its game client 52.1 or 54.1 in cooperation with the game server 56. In this mode the player can interact with the game by pressing the appropriate buttons 22, and by viewing the machine's display 14. The other mode is an event mode, in which the game is suspended so that event information, which is transferred from the event server 58, can be acted upon by the gaming machine 52, 54. Where appropriate, actions can be taken by the player to participate in or interact with the event. In the event mode the event client 52.2 or 54.2 will cause relevant event information to be transferred from the gaming machine 52 or 54 to the event server 58. In a preferred embodiment, when the gaming machines 52 and 54 are in an event mode the processing of games by the games clients 52.1 and 54.1, and communications between the games clients and the game server 56 in relation to the playing of games is suspended.

It should be noted that since events are run separately to the games, and the events do not directly affect the games being played on the gaming machines 52 or 54, the timing of the events and the communication event information from the event server 58 is largely independent of the timing of the content of any of the games. Thus, in certain embodiments it is necessary to determine how conflicts between games and events in relation to the timing of demands for gaming machine processing time, should be handled. Typically the game client will be given priority over an event client, however this may not always be the case.

In the preferred embodiments an event client is typically passive, that is, it is typically inactive and awaits the receipt of event information from the event server before becoming active. On the other hand the game client is active and will keep running until it is interrupted. In this regard the receipt of an event request from the event server by a gaming machine are effectively “suspend” commands to allow control on the game clients 52.1 and 52.2 to be suspended and effectively to be switched over to the event clients 52.2 and 54.2. However, if a game is underway, then this “suspending” only occurs, in one preferred embodiment, once the game comes to an end. In other words, the nature of the signals transmitted from the event clients 52.2 and 54.2 to the game clients 52.1 and 54.1 is such that, if a gaming machine 52 or 54 is not ready to be switched to its respective event mode of operation because a game is underway, then the game may continue until its end or until a suitable state is reached in which the game may be suspended. In this case, event information must be stored until an appropriate time, and at that time, the game clients must stop processing game information so that the event clients can assume control of the machines for the duration of the event. Such an appropriate time may, for example, be at the end of the game. Once this appropriate time has arrived, the event information can be acted upon, first by way of the switching means 66 switching the gaming machine 52 or 54 to the event mode, in which case the clients 52.2 or 54.2 handle the communications between the respective gaming machines and the event server.

While in the above preferred embodiment the suspending of the players' control over the gaming machines occurs at the end of the game, in other embodiments it might occur at a different time. The appropriate time to suspend such control—referred to as a “checkpoint”—may depend on the jurisdiction in which the relevant gaming establishment is located. The checkpoint may also depend on the technological features of the gaming machines 52 and 54, the game server 56 and event server 58. In addition, where the technological features permit, the checkpoint may also possibly depend on the requirements of the gaming establishment itself.

The “suspend” commands referred to above have the effect of preventing the inputs, made by players who are using the controls 24, from having any effect on the games played on the gaming machines 52 and 54, to the extent that these games involve the game clients 52.1 and 54.1 and game server 56.

In order that the event clients 52.2 and 54.2 will “know” that the game clients 52.1 and 54.1 are in the locked-up, passive state, appropriate signals are sent from the game clients to the event clients. The event clients 52.2 and 54.2 at this stage are in an active state, not only for handling transmissions of event information from the event server 18, but also for managing signals from the controls buttons 24 of the machines 52 and 54.

It will thus be appreciated that, while the gaming machines 52 and 54 are in their respective event modes, the machines are adapted for the players to interact with the machines for the purpose of viewing event information and transferring event information from the gaming machines to the event server 58. This interaction involves the viewing of information displayed on the machines' displays 22, and possibly also the players controlling the operation of the gaming machines 52 and 54. During this time, the event information is being handled by the event clients 52.2 and 54.2 of the gaming machines 52 and 54.

When a gaming machine 52 or 54 is in an event mode of operation, there may be certain functions which continue to be handled by the machines' game clients 52.1 and 54.1, such as the operation of the coin- and banknote-receiving slot components 24, respectively, and the coin hopper component 30, as well as the handling of certain game-related information such as statistical and auditing information which is communicated to, and from, the game server 56, and so on.

When the service provided by the event server 18 is complete, i.e. when all actions relating to the event feature have been completed control of the gaming machine 52, 54, then the managing of reverts to the game clients 52.1 and 54.1. For effecting this change, the event clients 52.2 and 54.2 send signals to the respective game clients 52.1 and 54.1 causing the game clients once again to become active and to resume the management of, and receptiveness to, player interactions with the gaming machines 52 and 54.

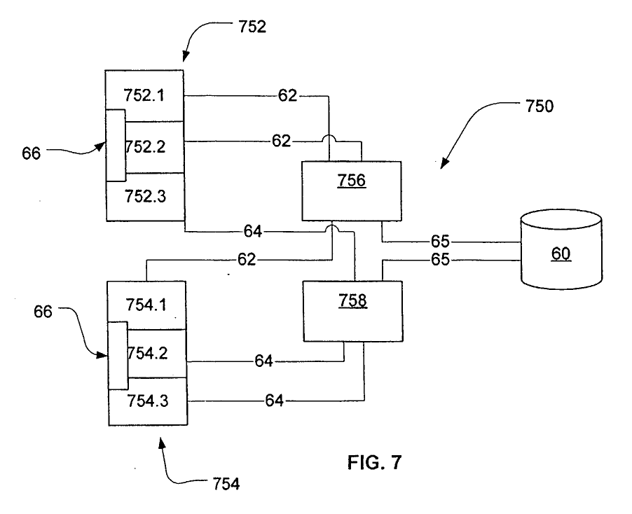

In some embodiments, such as that shown in FIG. 7, each gaming machine may be equipped with more than one event client to enable the machine to handle more than one type of event. In certain embodiments the multiple event clients can operate concurrently or at different times. In this case, once control of the respective gaming machine has been handed back to the game clients 52.1 and 54.1, each of the event clients will be in a passive state.

In addition, each gaming machine may, in some embodiments, be provided with more than one game client to enable the machine to handle more than one game. Depending on the configuration, these different games may be handled at different times from one another, or concurrently. Thus, it would, in such embodiments, be necessary to provide the gaming machines with means, similar to the switching means 66, for switching the machine between the game clients to enable switching between the various games handled by the different game clients. Alternatively, where the games are being run simultaneously, means may be provided for co-coordinating the input of the player via the controls of the machines (such as the button controls 24) so as to achieve a uniform effect among all of the games that are in progress so that such input has a similar effect on all of the games.

As will be appreciated, depending on the exact implementation of the system, the running of a game can be split between the game client of a gaming machine and a game server in different proportions. These range between one embodiment in which the split between the game client and game server is such that the game client essentially runs the game with only certain information about the game, such as statistical, or auditing, information being communicated to the game server 56, and a another embodiment in which the game server 56 essentially runs the game with the game client only being responsible for controlling the player interface of the game, e.g. by generating screen displays and transmitting player input data back to the server. Clearly embodiments can also be implemented in which the running of the game may be more evenly split between the gaming machine and the game server 56, with certain of the functions of the game being run on the gaming machine 52 or 54 itself, and certain other functions on the game server 16. The game server can retrieve stored data, which may be required during the course of a game, from the data storage means 20.

The operation of the system 50 will now be described in broad terms by way of an example. According to this example, both of the gaming machines 52 and 54 are in their respective games modes with players playing games on the machines. Event information relating to a promotion is then generated in an event server of the system. This causes a signal from the event server 58 to be transmitted to the gaming machines 52 and 54. This, in turn, causes the respective switching means 66 to switch the machines from their games modes to their event modes when each of the games is completed so that the ability to continue playing games on the gaming machines is suspended.

Once the gaming machines 52 and 54 are in the respective event modes, the event information, transmitted from the event server 58, can be displayed on the displays 22 of the gaming machines 52 and 54. Once each player has had an opportunity to view or consider the event information, or interact with the event where appropriate, the switching means 66 can switch the machines back into their games modes to allow the players to continue playing further games.

Depending on the configuration of the system 50 reversion of the gaming machines 52, 54 back to game modes may occur after the event clients 52.2 and 54.2 send signals to their respective game clients 52.1 and 54.1 relating to the completion of the event. In a preferred embodiment, this happens after the results of the event have been displayed to the player on the relevant display 22 followed by a suitable passage of time, or followed by the player indicating, by way of operating appropriate controls 24 on the gaming machine 52 or 54, that he wishes to continue playing a game.

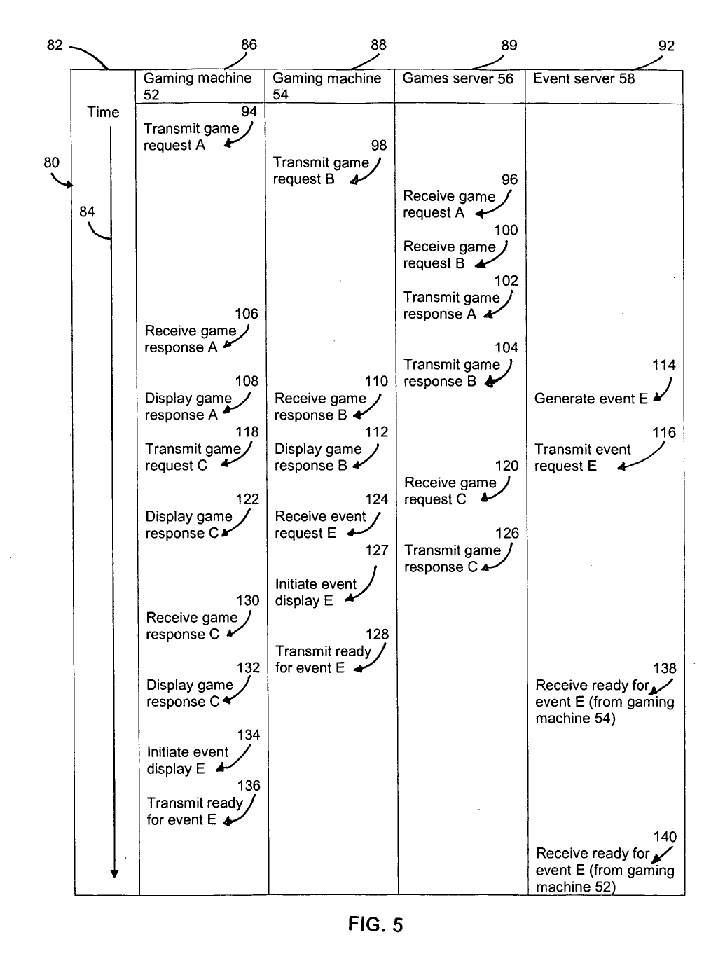

The operation of the system 50 is described in more detail, by way of example with reference to FIG. 5. In this figure, there is shown a flow chart 80 which indicates actions performed by the two gaming machines 52 and 54, by the game server 56, and by the event server 58. In the example, the playing of games by the players is described in terms of the players transmitting game requests (representing the actions of the players when playing the games) and the transmitting of responses by the game server 56 (representing responses, by the game server, to the actions of the players).

The flow chart 80 includes a left column 82 in which a vertical arrow 84 represents the passage of time. The next column 86 reflects the actions performed by the gaming machine 52 (by its game client 52.1 or event client 52.2), while the column 88 next to that reflects the actions performed by the gaming machine 54 (by its game client 54.1 or event client 54.2). The next column 90 reflects the actions performed by the game server 56, and the column 92 next to that reflects the actions of the event server 58.

At the start of the time period shown each of the gaming machines 52 and 54, are in their respective game modes in which the game clients 52.1 and 54.1 are configured to communicate with the game server 90 to allow the playing of games on those machines.

In step 94, by the gaming machine 52, as shown in the column 86, transmits a game request A to the game server 56. The game request will typically be issued in response to an action of the player, such as insertion of a coin or the pressing of an appropriate button on the gaming machine 52. This game request A is received by the game server 56 in step 96, as shown in the column 90.

Similarly, in next step 98 the gaming machine 54, as shown in the column 88, transmits a game request B to the game server 56. This game request B is received by the game server 56 in step 100, as shown in the column 90.

The game server 56, in step 102, then transmits, a game response A to gaming machine 52. It then transmits, in step 104, a game response B to gaming machine 54.

The game response A transmitted by the game server 56 in step 102 is received by the gaming machine 52 in step 106. Thereafter, this gaming machine, in step 108, displays the game response A on the display of the gaming machine for the information of the player using that machine marking the end of the game that has been underway on gaming machine 52. Similarly, the game response B transmitted by the game server 56 in step 104 is received by the gaming machine 54 in step 110. Thereafter, that gaming machine 54, in step 112, displays game response B on the display of that gaming machine for the information of the player using that machine. This marks the end of the game that has been underway on the gaming machine 54.

In the meantime, the event server 58 has generated an event E in step 114 as shown in the column 92. In the present example, the generation of event E has occurred around the same time that step 108 was performed by the gaming machine 52, and prior to the performance of step 112 by the gaming machine 54. in the present example, the nature of the event E generated by the event server 58 is such that it will require a response by the players of the gaming machines 52, 54. An example of such an event is a promotional competition to which the players must respond in order to be eligible to win the competition.

The event E is then transmitted by, the event server 58, in step 116 to the gaming machines 52 and 54.

At about the same time that the event server 58 transmits event E to the gaming machine 52, 54, gaming machine 52, in step 118, transmits another game request, namely game request C, to the game server 56, to initiate a new game.

The game server 56 receives game request C from the gaming machine 52 in step 120. Following this both of the gaming machines 52 and 54, in steps 122 and 124 respectively, receive the event request E that was transmitted by the event server 58 in step 116.

Next the game server 56, in step 126 transmits a game response C to the gaming machine 52 in response to the game request C.

As there is no game under way on gaming machine 54 (as the game that was being played had already ended as mentioned above), this gaming machine is free to immediately initiate, in step 127, the display of the event E for the information of the player on that machine. This involves the event client 54.2 assuming control of the gaming machine 54 transferred to it by the switching means 66.

When the event E is displayed, the player on the gaming machine 54 can provide the appropriate or desired response by operating the relevant controls on that machine. This, in turn, causes a response to be transmitted, in step 128, from the gaming machine 54 to the event server 58, indicating that the player is ready to participate in event E. This is referred to, for convenience, as a “ready for event” transmission.

In the meantime the game being played on the gaming machine 52 remains underway, and this machine is therefore not in a state to initiate the display of the event E immediately when the event request E is received in step 122. Rather, the next step performed by the gaming machine 52 is step 130, which involves receiving the game response C transmitted from the game server 56 in step 120. This is then followed by step 132 in which the game response C is displayed on the display 22 of gaming machine 52.

According to the present example, step 132 marks the end of the game that was being played on the gaming machine 52. Gaming machine is then in a state in which it can initiate the display of the event E. It does this in step 134. To enable this, the relevant event client 52.2 has control of the machine 52 switched to it by the switching means 66.

When the event E is displayed, the player on the gaming machine 52 can provide the appropriate or desired response to that event by operating the relevant controls, on that machine. This, in turn, causes a “ready for event” response to be transmitted, in step 136, from the gaming machine 52 to the event server 58, indicating that the player is ready to participate in the event E.

The “ready for event” transmission made from the gaming machine 54 in step 128, is received by the event server 58 in step 138, while that from the gaming machine 52 is received by the event server in step 140, Once both “ready for event” transmissions are received from the gaming machines 52 and 54, the event server 58 can operate and interact with the event clients 52.2, 54.2 of respective gaming machines 52, 54 to allow for the participation of the players in the event E. In particular, if the system is configured for the event to be run on all of the machines simultaneously, then as soon as the machines are all ready (with no games being run), the running of the event may proceed.

It is to be understood that as the steps occur in the flowchart 80, the initial communication from the event server 58 to the gaming machines 52 and 54 occurs while they are in their game modes. However, once the respective games have ended, as represented by step 112 for the gaming machine 54 and step 132 for the gaming machine 52, the switching means 66 of the gaming machines switch their respective machines into an event mode so that the further communications in this mode are between the event clients 52.2 and 54.2 of the gaming machines and the event server 58.

In the present example the switching of a gaming machine from the game mode to its event mode can only occur after the game has terminated. However in other embodiments alternative “check points” may be used.

In a particular embodiment the system can include a number of gaming machines in addition to the gaming machines 52 and 54 which are configured to enable players to play in a co-operative arrangement in relation to events that are generated. In particular, the system is configured for an event to be triggered by a certain game-play event on any one of the cooperating gaming machines. It is also configured, in the event of an award winning condition being met, to make one type of award to the player of the machine which triggered the event, and another type of award to the other cooperating gaming machines. Prior to such an event being generated, the game clients of the various gaming machines interact with the game server 56. At this stage the event server 58 is monitoring the gaming machines for the particular occurrence which triggers the generation of the event. When such an occurrence occurs at one of the machines, the event server 58 sends a signal to the event client of each of the gaming machines in a similar manner to that described above.

Assuming that this event involves the automatic issuing of an award, as soon as the game client event clients of all of the machines are suspended and their event clients activated the event client of the machine that triggered the event is instructed by the event server 58 (by way of appropriate signals being sent) to display, on that machine's display 22, the award designated for that machine. Similarly, the event clients of the other cooperating gaming machines are similarly instructed to display their respective award to its player

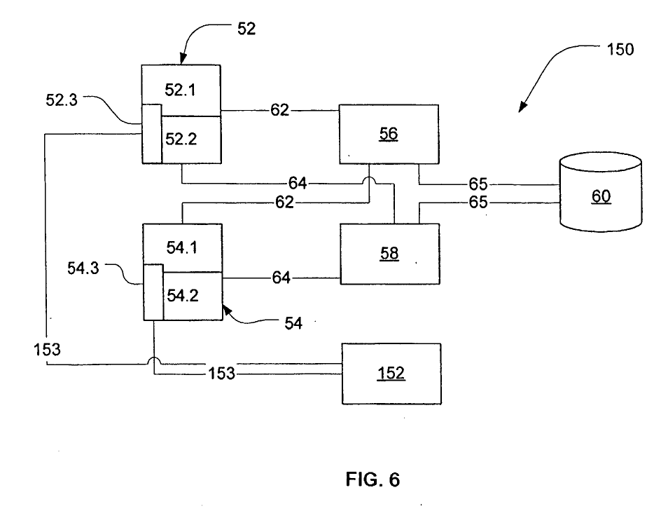

In the embodiments above, the clients of the gaming machines 52 and 54 are constituted by the game clients 52.1 and 54.1 and the event clients 52.2 and 54.2, where the game clients and event clients are configured for handling, respectively, games being played on the gaming machines and events transmitted from the event server 58. However, in another embodiment of the invention as reflected in FIG. 6, each gaming machine 52 and 54 has a game client 52.1. and 54.1 and one or more additional, component clients 52.3 and 54.3 which are constituted by peripheral components of the gaming machine, such as the display 14, the buttons 22, the coin-receipt slot component 24.1, the banknote receipt slot component 24.2, or the prize-award coin hopper component 40.

In the system 150 of this embodiment, features corresponding to features in the system 50 described above are designated with corresponding reference numerals. Accordingly, the system 150 includes a game server 56 and an event server 58. In addition the system 150 includes a component server 152 for each type of component client 52.3 or 54.3. The component clients 52.3 and 54.3 are connected to the component server 152 by connections 153.

Thus, for example, while a game is underway on a gaming machine 52 or 54 under control of the respective game client 52.1, 54.1, assuming that the component clients 52.3 and 54.3 in this example are the coin- and banknote-receipt slot components 24.1 and 24.2, information about the operation of these peripheral components, such as the number of coins or banknotes to be inserted into the gaming machine during a particular period, or the monetary denominations used, can be communicated to the relevant component server 152. This may allow, for instance, suitable statistical or auditing calculations to be carried out which may be of-use” to the gaming establishment.

These component clients 52.3 and 54.3 are clients in their own right, and their operation may therefore be independent of the operation of the game clients 52.1 and 54.1 on the gaming machines 52 and 54. In certain embodiments they may also run as stand alone processes. As a result, the transfer of communications from these component clients to the component server 152 can occur while a game (or event) is underway, without the software for running that game (or event) having to be specifically adapted to permit such communication with the component clients 52.3 and 54.3.

Although this embodiment is described with reference to the component clients 52.3 and 54.3 being constituted by the coin- and banknote-receipt slot components 26 and 28, it will be appreciated that anyone or more of the peripheral components of the gaming machines 52 and 54 may be implemented as independent client processes. Furthermore, there may be one or more separate component servers 152 for each type of component client of the gaming machines 52 and 54, or one type of component server might be configured to serve more than one type of component client as in the present embodiment where the server 152 represented in FIG. 6 serves both the coin-receipt slot components 24.1 and the banknote-receipt slot components 24.2.

In addition, this embodiment may also involve a separate event client 52.2 and 54.2 for each gaming machine 52 and 54 as described above in relation to FIGS. 3 and 4, or may be similar to the prior art system 10 described above to the extent that the machines do not have separate event clients.

FIG. 7 depicts another embodiment of the present invention. The operation of the system of FIG. 7 is essentially the same as that of previous embodiments, and no detailed description of this embodiment will be necessary.

In FIG. 7 the system 700 includes two gaming machines 752 and 754 and a game server 756, an event server 758 and a database 60. Connections between these components are similar to those of FIGS. 2 and 6 and are labelled accordingly.

In this example gaming machine 752 includes two game clients 752.1 and 752.2 and an event 752.3. Gaming machine 754 includes a game client 754.1 and two event clients 754.2 and 754.3. The game server 756 is connected to the game clients 752.1, 752.2 and 754.1 of the gaming machines 752 and 754, and the event server 758 is connected to the event clients 752.3 and 754.2, 754.3 of the gaming machines 752 and 754.

In this example the gaming machine 752 is configured to allow a player to play two different types games each corresponding to one of the game clients residing thereon, whereas the gaming machine 754 can play only one type of game, by virtue of it only possessing a single game client. Conversely a player of gaming machine 752 can only take part in the event corresponding to event client 752.3, whereas gaming machine can take part on two types of events corresponding to event clients 754.2 and 754.3. The gaming machines also include a respective switching components 66, of the type described above, that controls which client application is controlling the gaming machine at any point in time.

It should be noted that in the present embodiment the game server 756 is the server for all games playable on the gaming machines 752 and 754. However it is possible for each different type of game to be controlled by a separate server. Similarly with events, one or more event clients can be used if multiple events are to be run on a gaming system, possibly with each type of event being given a dedicated event server.

Although this invention is described above in relation to specific embodiments, it is to be understood that it is not limited in that regard, but may be embodied in many other forms. For example, the embodiments described in relation to FIGS. 4 and 5 are adapted such that the relevant gaming machine is only switched from its game mode into its event mode once the game that was being played has come to an end. However, in another embodiment, the system 50 may be adapted for the relevant gaming machine to switch from the games mode to the event mode immediately or very soon once signals relating to-the generation of the event are received by the respective event clients 52.2 and 54.2. In this event, where a game is underway, the current phase or state of the game must be stored to enable the game to continue from the same place once the gaming machine switches back to the games mode. If any responses are awaited by the gaming machine 52 or 54 from the games server 56, then the gaming machine will not switch to the events mode until the response has been received. It will then store information relating to the current phase or state of the game before switching control to the event clients 52.2 and 54.2 and event server 58. This embodiment is particularly relevant in a case where the games played on the gaming machines 52 and 54 involving the game clients 52.1 and 54.1 are played in discreet stages. In this case, the system 50 may be adapted for each gaming machine only to switch into the event mode when a particular game stage (as opposed to the whole game) is completed.

1. A gaming system including:
a plurality of gaming machines each having:
a player display interface,
a player control interface,
a game client and an event client;
a game server connected to at least one of the game clients; and
an event server connected to at least one of the event clients,
wherein each of the game clients is configured, in conjunction with the game server, to enable a game to be played thereon, and each of the event clients is configured to handle an event, which does not constitute part of said game, by receiving signals from an event server relating to the event and by causing information about the event to be displayed on said display interface.

2. The gaming system of claim 1 wherein the event client of each gaming machine is configured to handle the event by responding to commands, relating to the event, input by the respective player using said player control interfaces.

3. The gaming system of claim 1 wherein, each gaming machine is configured to prevent a game from being played by the respective game client in conjunction with the game server, while the event client is handling an event.

4-5. (canceled)

6. A method for operating a gaming machine played by a player, the gaming machine of the type having a display, said method comprising:
controlling the display with a game client in cooperation with a game controlling server to display game outcomes;
providing an event server configured to control at least a portion of the display in cooperation with an event client resident on the gaming machine to display an event; wherein
at least between the display of game outcomes, said event server and event client cooperate to control the display to display event data.

7. The method of claim 6 further comprising at least one of said event server or game server suspending control of the display of said event data until a predetermined interruption of the display of game play outcomes.

8. The method of claim 6 further comprising the player inputting data during the period in which said event server controls the display.

9. The method of claim 8 further comprising the player inputting data during the period in which said event server controls the display to interact with an event.

10. A gaming system including at least one gaming machine operably connected to at least one game server and at least one additional server; said gaming machine being configured to run at least one game client application configured to cooperate with a corresponding game server to enable a game to be played on the gaming machine and at least one additional client configured to cooperate with a corresponding additional server to implement an additional functionality of the gaming machine.

11. The gaming system of claim 10 wherein the at least one additional second client includes an event client application configured to cooperate with an event server to enable the operation of an event involving the gaming machine.

12. The gaming system of claim 10 wherein the at least one second client includes a component client configured to cooperate with a component server to control the operation of one or more physical components of the gaming machine.

13. (canceled)

14. The gaming system of claim 8 wherein the at least one second client includes a feature game client configured to cooperate with a feature game server to control the operation of one or more feature games playable on the gaming machine, wherein said feature game is not related to one or more base games playable on the gaming machine.

15. The gaming system of claim 11 wherein an event client is configured to implement one of the following:
the operation of a jackpot;
the operation of a competition;
the operation of a promotion; or
the operation of a bonus feature not forming part of a base game implemented by a game client/server combination of the system.

16. The gaming system of claim 12 wherein a component client is configured to control the operation of at least one of the following gaming machine components:
a display;
a credit input means;
an auditing component;
an audio system;
a player identification system;
a player input system; and
a credit payout system.

17. The gaming system of claim 10 wherein the gaming machine further includes at least one client switching component configured to switch the control of the gaming machine between different client applications to enable the operation of either an event or a game.

18. A gaming machine including at least one data storage component for storing at least one game client application and at least one additional client application and processing means configured to run one or more of said client applications to control the operation of the gaming machine, wherein said gaming machine is configured to be operable under the control of game client application to enable a game to be played thereon, and to be operable under the control of an additional client application to implement an additional function of the gaming machine.

19. The gaming machine of claim 18 wherein an additional client is an event client, configured to enable the gaming machine to take part in an event.

20. The gaming machine of claim 18 wherein an additional client is a component client configured to control the operation of a component of the gaming machine.

21. The gaming machine of claim 17 wherein an additional client is a feature game client, configured to enable the gaming machine to take part in feature game that is not related to one or more base games playable on the gaming machine.

22. The gaming machine of claim 17 which further includes a client switching component configured to switch the control of the gaming machine from one client application to another.

23. The gaming machine of claim 19 wherein an event client is configured to implement one of the following:
the operation of a jackpot;
the operation of a competition;
the operation of a promotion; or
the operation of a bonus feature not forming part of a base game implemented by a game client/server combination of the system.

24. The gaming machine of claim 20 wherein a component client is configured to control the operation of at least one of the following gaming machine components:
a display;
a credit input means;
an auditing component;
an audio system:
a player identification system;
a player input system; and
a credit payout system.

25. A method of operating a gaming machine including at least one data storage component for storing at least one game client application and at least one additional client application and processing means configured to run one or more of said client applications to control the operation of the gaming machine, said method including:
controlling the operation of the gaming machine with a game client application to enable a game to be played thereon; and
controlling the operation of the gaming machine with an additional client application to enable an additional function to be performed by the gaming machine.

26. The method of claim 25 which further includes:
switching control of the gaming machine from one client application to another to enable control of a different function of the gaming machine.

27. The method of claim 25 wherein the additional client is selected from a list including:
an event client configured to enable the gaming machine to take part in an event;
a component client configured to enable the gaming machine to control a component of the gaming machine; and
a feature game client configured to enable a feature game, not related to one or more base games playable on the gaming machine, to be played on the gaming machine.
